(19) United States
(12) Patent Application Publication
(10) Pub. No.: US 2025/0297494 A1
(43) Pub. Date: Sep. 25, 2025

(54) Gate Lockbox latch

(71) Applicant: Cheylen Phillip LePage, Palmdale, CA (US)

(72) Inventor: Cheylen Phillip LePage, Palmdale, CA (US)

(21) Appl. No.: 18/612,616

(22) Filed: Mar. 21, 2024

(51) Int. Cl. E05B 63/00; E05C 1/04

(52) U.S. Cl. CPC E05B 63/0017; E05C 1/04

(57) ABSTRACT

One embodiment an elongated housing 12 in which a bolt latch 13 is manually moved through by of handles 20a and 20b connected to ends of an actuator rod 14; the actuator rod 14 is directly attached to the bolt latch 13; so that a user of this gate latch can actuate the sliding bolt latch 13 from both sides of the gate and lockbox casing 15 is adapted for mounting any standard double cylinder dead bolt lock 21 is adjacently attached to the side of the elongated housing 12 so the user can key turn the double cylinder dead bolt 21 and extending the deadbolt 18 into the elongated housing 12 engaging the notch 19 on the bolt latch 13 securing its movement and preventing entry from trespassers and having the convenience of locking or unlocking from either side of the hinged gate.

### CROSS-REFERENCE TO RELATED APPLICATIONS

This application claims the benefit of provisional Ser No. U.S. 63/453,753, filed 2023 Mar. 21 by the present inventor.

### BACKGROUND—PRIOR ART

The Following is a tabulation of some prior art that presently appears relevant:

### U.S. Patents

| Patent number | kind code | issue dates | patentee |
|---|---|---|---|
| 4,565,079 | B1 | 1986 Jan. 21 | Smith |
| 5,678,432 | B1 | 1997 Oct. 21 | Teskey |
| 11,131,116 | B2 | 2021 Sep. 28 | Patrick, Selwood |

Gate latches and gate locks on the market commonly supply a latch design for just one side of the gate to allow entry. While other common latch designs have a thumb handle or cable to lift the gate latch on the opposite side of gate freeing the latch bar for entry with the option of using a pad lock, but the pad lock cannot be unlocked from both sides.

Gate latch design concepts have improved with allowing entry from both sides with using keyable methods from both sides but limited to a common residential side gate with only option to using that company's lock parts for that their latch lock system.

Options for keyable entry for both sides of gate consist of many different and connected parts, eventual malfunction, or break is inevitable in short time span.

The manual sliding gate latches available on the market lack the option to install a double cylinder deadbolt lock with the ability to lock, unlock and have handles from both sides of gate.

### SUMMARY

This is embodiment is a horizontal sliding latch incorporated with a gate lockbox for option of installing a standard double cylinder deadbolt lock of choice. This embodiment does not have a lock internally installed; this embodiment is primarily a latch bolt with an empty bore hole (no deadbolt included) that would give advantage to choose any standard common double cylinder deadbolt lock on the market.

The gate latch (bolt latch) slides within an elongated casing horizontally for locking and unlocking positions. After the install of the standard deadbolt, the bolt of the installed deadbolt vertically projects into the gate latch bolts notch perpendicularly.

### DRAWINGS—REFERENCE NUMERALS

| | |
|---|---|
| 12 elongated housing | 13 bolt latch |
| 14 actuator rod | 15 lockbox casing |
| 16 bore hole | 17 edge bore |
| 18 deadbolt | 19 notch |
| 20a R-handle | 20b L-handle |
| 21 double cylinder deadbolt lock | 22a R-elongated slot |
| 22b L-elongated slot | 23 bolt latch attachment point |
| 24 elongated housing opening | 25 bolt assembly |
| 26 bolt face plate | 27 fence post |
| 28 hinged gate | |

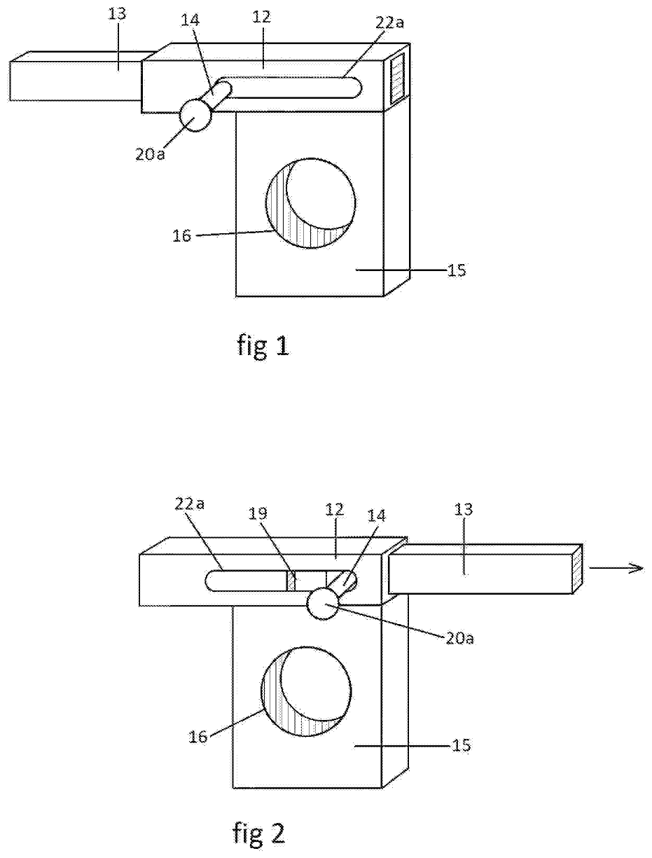

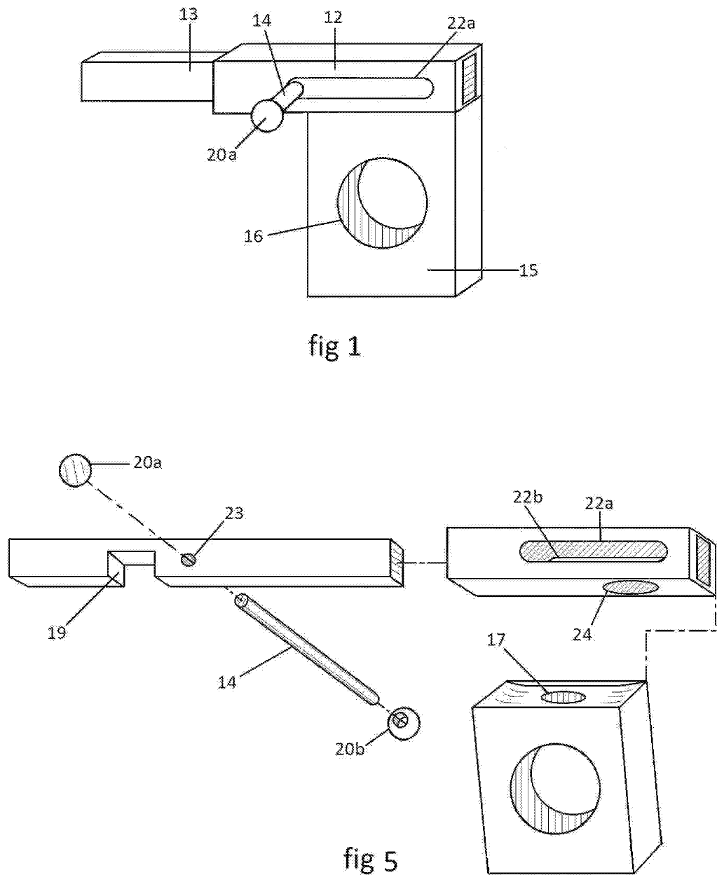

### DETAILED DESCRIPTION—FIGS. 1 THOUGH 9

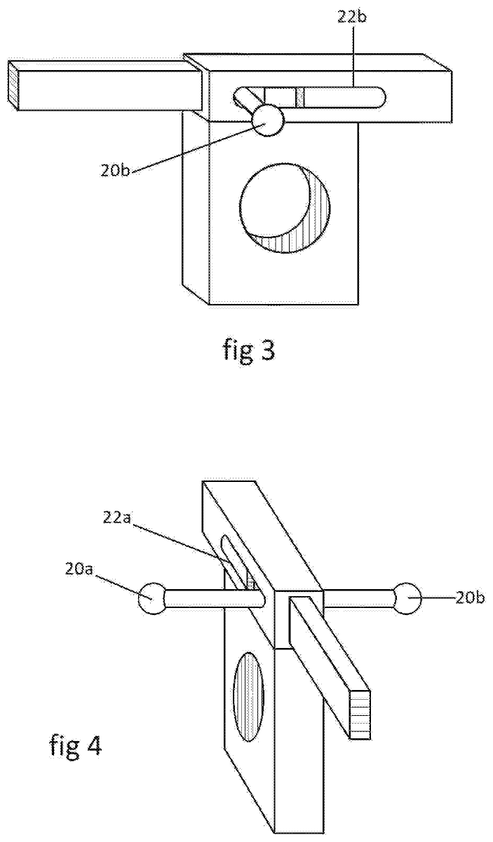

Referring to FIG. 1 the embodiment includes a lockbox casing 15 with a borehole 16 through it. A elongated housing 12 with a bolt latch 13 guidably mounted within in a retracted position. One handle is shown in FIG. 1 handle 20a and the other handle 20b shown in FIG. 3 and FIG. 4.

In FIG. 1 the actuator rod 14 is attached to bolt latch attachment point 23 on the bolt latch 13 through two elongated slots 22a and 22b shown in FIG. 3.

In FIG. 1 the bolt latch 13 is in a retracted unlocked position whereas in FIG. 2 shows the bolt latch 13 in an advanced extended position.

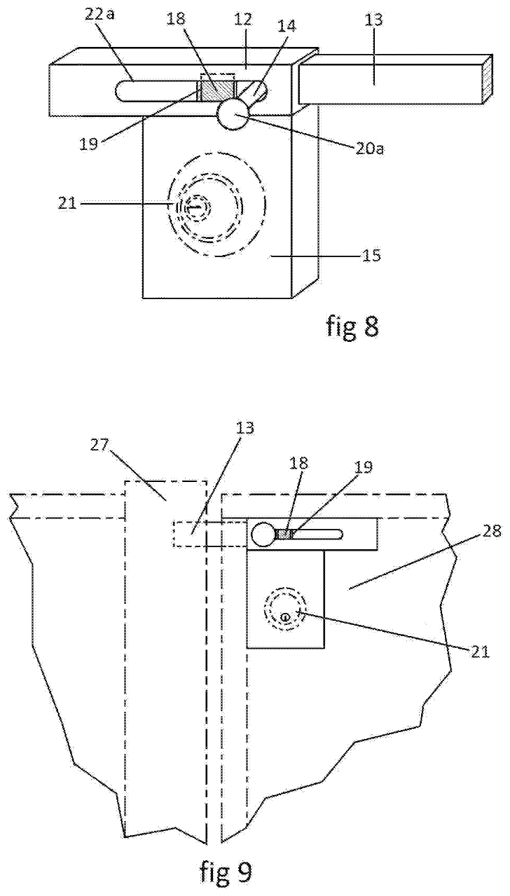

In FIG. 5 in this exploded view edge bore 17 and elongated housing opening 24 are lined up for the deadbolt 18 to move through show in FIG. 8.

In FIG. 8 the deadbolt 18 engages into the notch 19 of the bolt latch 13 retaining the movement of the bolt latch 13.

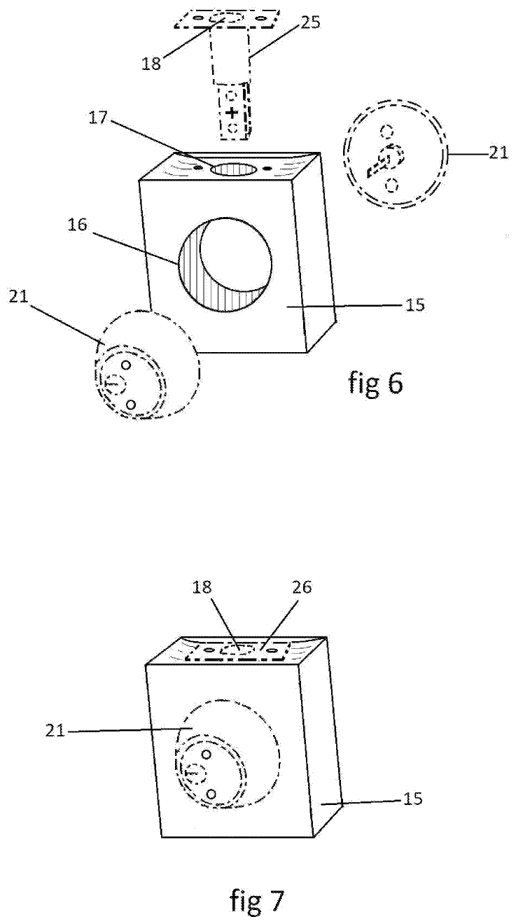

In FIG. 6 shows the install process of where and how the user would need to install the double cylinder deadbolt lock 21 into the bore hole 16 and bolt assembly 25 into the edge bore 17 and in FIG. 7 shows the complete install of double cylinder deadbolt lock 21 in lockbox casing 15 before the user would assemble the elongated housing 12 to the lockbox casing 15.

In FIG. 9 shows a fragmentary side elevational view of the embodiment installed on a wood or metal swinging hinged gate 28. The bolt latch 13 is shown extended inside an adjacent fence post 27 securing the gate from swinging. The deadbolt 18 is shown extended into notch 19 of the bolt latch 13 securing the movement of the bolt latch 13 from an intruder.

1. A gate lockbox latch assembly for operating in conjunction with a standard double cylinder deadbolt lock said gate lockbox latch comprising:
an elongated housing;
a manually reciprocal bolt latch guided by mounts within said elongated housing from an unlocked retracted position and projectable therefrom to a lock position by an actuator rod attached transversely to said bolt latch; the two ends of said actuator rod extend through elongated slots on opposite sides of said elongated housing;
a pair of handles are coupled to the ends of said actuator rod;
a lockbox casing with a borehole and edge bore adapted for the mounting of said deadbolt lock is attached to said elongated housing;
a notch in said bolt latch is aligned to receive a dead bolt from said deadbolt lock through said edge bore into an opening of said elongated housing whereby securing said bolt latch in lock position.
